(19) United States
(12) Patent Application Publication
(10) Pub. No.: US 2011/0082769 A1
(43) Pub. Date: Apr. 7, 2011

(54) METHOD FOR MANAGING ITEM QUANTITIES IN AN ECOMMERCE ENVIRONMENT

(76) Inventor: Ryan Daniel Hatfield, Austin, TX (US)

(21) Appl. No.: 12/573,062

(22) Filed: Oct. 2, 2009

(51) Int. Cl. G06Q 10/00; G06F 15/16; G06Q 30/00

(52) U.S. Cl. 705/26.61; 709/206; 705/28

(57) ABSTRACT

The present invention provides a computer-implemented method for managing the quantity of at least one item on an ecommerce site. The method includes the steps of monitoring an ecommerce site where at least one item of interest is listed, receiving from the ecommerce site a message relating to a quantity of the item of interest, setting a predetermined displayed quantity of the item of interest that is visible to potential buyers using the ecommerce site, and repeating these steps so long as the item is listed on the ecommerce site. The computer-implemented method is performed by at least one computer programmed to perform these various steps.

### RELATED APPLICATIONS

Not Applicable.

### BACKGROUND OF THE INVENTION

The present invention relates generally to a computer-implemented method, and more specifically to a computer-implemented method for managing item quantities in an ecommerce environment.

Over the past decade or so, the growth of ecommerce sites has been phenomenal. Of such sites, eBay is by far the most successful. As of this writing, eBay has hundreds of millions of users worldwide, and has revenues exceeding seven and a half billion dollars. Of these users, many are sellers who use eBay as a means to supplement their income.

Given the vast number of users making purchases via ecommerce sites like eBay, sellers are constantly looking for methods of distinguishing themselves and their goods from those of other users, and for methods of increasing the total number of sales they are able to achieve on the ecommerce site. Books, audiovisual materials, and internet web sites are devoted to strategies for increasing sales on ecommerce sites, and specifically on eBay.

Typical ecommerce sites function in ways that run contrary to buyer behavior. For example, such sites are set up so that a seller typically lists an item and includes in the listing the total quantity of that item available for sale. For sellers who have multiple units of a given item, sales may be slow because buyers tend to purchase an item more readily when the item is scarce. Sellers may manually manipulate their listings to create an apparent scarcity, but doing so is time-consuming and inefficient. Typical ecommerce sites, such as eBay, are designed in a manner contrary to this goal.

What is needed, then, is an easy to use, automated method for sellers who wish to manage a quantity of items for sale on an ecommerce site such that there is an apparent scarcity of the item being sold.

### SUMMARY OF THE INVENTION

The present invention provides a computer-implemented method for managing the quantity of at least one item on an ecommerce site. The method includes the steps of monitoring an ecommerce site where at least one item of interest is listed, receiving from the ecommerce site a message relating to a quantity of the item of interest, setting a predetermined displayed quantity of the item of interest that is visible to potential buyers using the ecommerce site, and repeating these steps so long as the item is listed on the ecommerce site. The computer-implemented method is performed by at least one computer programmed to perform these various steps.

In one aspect of the present invention, the monitoring of the ecommerce site is performed in real time.

In another aspect of the present invention, the steps recited above are repeated for every item listed on the ecommerce site by the user of the present method.

In another aspect of the present invention, a method for managing the quantity of at least one item listed by a user on an ecommerce site is provided, including the steps of monitoring an ecommerce site, receiving from the site a message relating to at least one listing of an item of interest, and overriding the displayed quantity of each item of interest listed on the ecommerce site such that the displayed quantity corresponds to a preselected value set by the user of the present method. These steps are repeated so long as the user has at least one listing on the ecommerce site.

In another aspect of the present method, a computer-implemented method for managing the quantity of at least one item listed on an ecommerce site is provided. The method includes the steps of receiving from a user information regarding at least one ecommerce site where the user has items listed for sale, prompting the user to set default values for Inventory and Display of items listed on the ecommerce site, updating each of the user's listing on the ecommerce site to reflect the user-selected value for Display, monitoring said ecommerce site, receiving from the ecommerce site information relating to the purchase of listed items on the ecommerce site, determining the quantity of items purchased, and updating the value for Inventory for the listed items by subtracting the quantity purchased from the Inventory value, updating the displayed quantity the ecommerce site by setting the displayed quantity to the lesser of the Inventory and Display values. These steps are repeated so long as the user has items listed on the ecommerce site.

In another aspect of the present invention, an electronic message is sent to the user when the available quantity of the listed item reaches zero.

In still another aspect of the present invention, an electronic message is sent to the user when the Inventory of the listed item drops below a preselected value.

### BRIEF DESCRIPTION OF THE DRAWING FIGURES

FIG. 1 is a flowchart depicting the steps of initial setup involved in one implementation of the present method.

FIG. 2 is a flowchart depicting steps in the functioning of one implementation of the present method.

### DETAILED DESCRIPTION OF THE PREFERRED EMBODIMENTS

The present computer-implemented method is directed to managing a quantity of items being sold by a seller on an ecommerce web site. An exemplary ecommerce web site is eBay, though it is to be understood that the principles set forth herein may be applied to any suitable ecommerce site.

The present method may be implemented on at least one computer programmed to perform one or more of the steps described herein. In some implementations of the present method, more than one computer may be used, with each computer being programmed to carry out one or more steps of the present method. Such computer(s) may be general purpose computers, such as a desktop computer used by a seller wishing to manage a quantity of an item posted on an ecommerce site. It is contemplated, however, that any suitable computer may be used with the present method, any suitable computer being any computer that is capable of being programmed to perform one or more steps of the present method. Such computers include, but are not limited to, desktop computers, laptop computers, netbooks, cellular phones, smart phones, PDAs, gaming systems, and the like. Further, the present method is not limited by the operating system used by any such computer, nor by the programming language used to progam the computer to carry out one or more steps of the present method.

In general, the present method involves one or more computers used by a user of the present method, in communication with one or more computers being operated by an online auction web site. Communication between the two computers preferably occurs via the internet, but it is contemplated that such communication may occur in any suitable manner. Such computers may, for example, be in communication via a local-area network (LAN), wide-area network (WAN), virtual private network (VPN), cellular network, Bluetooth®, ethernet connection, USB connection, or any other suitable communication structure. The precise method of communication used between the various computers is not intended to be limiting, nor is the communication protocol used by the various computers. The present invention is limited only by the claims presented below, and not by exemplary hardware described herein.

Now provided is a detailed description of one implementation of the present method. As described below, the method is contemplated for use with the eBay ecommerce site, and the eBay API is used to provide the present method's functionality with respect to managing listings on eBay. The following is exemplary, and it is contemplated that the functionality described herein and claimed below may be adapted for use with any suitable ecommerce site. With respect to the following discussion, the following terms will be used:

“Qty”—as used below, the term “Qty” refers to the active quantity available for a listing on the ecommerce site. The Qty value is seen by potential buyers. In the implementation of the present invention described below, Qty=min(Inventory,Display), where Inventory is greater than zero and Display is greater than zero.

“Inventory”—as used below, the term “Inventory” refers to the actual amount of an item that a seller has available to sell.

“Display”—as used below, the term “Display” refers to the quantity of item available that a seller using the present method wishes to display to potential buyers. In most instances, the value of Display will be equal to the value of Qty.

A seller wishing to use the present method with respect to an ecommerce site may begin by logging on to a web site providing the functionality of the present method. In alternative implementations of the present method, the functionality of the present method may be provided via a stand-alone application, in which case the seller downloads the application onto a computer from which the user can use the software. For purposes of clarity in the present description, the functionality provided by the present method shall be referred to hereinafter as “Quantity Manager.” The description below covers the ‘front end’ of the Quantity Manager, which includes direct interaction with the system by a user thereof, and the ‘back end,’ which includes functionality taking place without the direct interaction of the user.

Front End

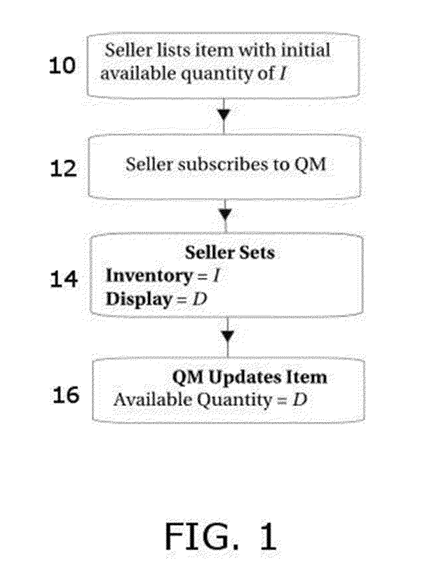

As shown in FIG. 1, a seller (referred to hereinafter as a user) may have pre-existing listings present on an ecommerce site. Thus, the user has already performed step 10, which is the provision of an initial available quantity of the listed item to the ecommerce site. The user then makes use of Quantity Manager as shown in step 12. When the user makes use of Quantity Manager, Quantity Manager downloads all of the user's current listings from the ecommerce site. This information is preferably downloaded in the background while the user uses Quantity Manager. The user is then presented with several options with respect to the retrieved listings. As represented by box 14, the user sets values within Quantity Manager, such as Inventory and Display values. Quantity Manager then updates the item on the ecommerce site in the step represented by box 16.

As the user begins to use the Quantity Manager implementation of the present method, the user is prompted to set the behavior of Quantity Manager as either ‘Smart’ or ‘Classic.’ Using the Smart setting, all future listings on the ecommerce site by the user will have their Display value set to the user's default, if in fact the user has established a default, at the time the listing is made, and the Inventory value is set to the initial Qty. If the Classic setting is chosen, Quantity Manager sets Inventory or Display to the user's default value, if set, and makes no further assumptions. Thus, the Smart behavior is similar to the Classic behavior, except that the value of Inventory is set to the value of Qty at the time of the listing.

After choosing whether to adopt a Smart or Classic behavior, the user sets the default values for Inventory and Display. The default value for Display is set if the user has chosen the Smart behavior for Quantity Manager, whereas if the user has chosen the Classic behavior then the Inventory and Display defaults are both set.

The user may also override the available quantity presented to a potential buyer at the time of listing. For example, if the user selects the Smart behavior, sets Display to 3, and then enables the override option, Quantity Manager will use these settings when updating a user's listings on an ecommerce site. With respect to a listing having an initial Qty of 100, Quantity Manager will update the listing to set Inventory to 100, Display to 3, and Qty to 3. Further, all future listings by the user will automatically include these values at the time of listing. Thus, in the preceding example, the available quantity seen by potential buyers browsing the ecommerce site will be 3, even though the user has an actual inventory of 100 for the listed items. In other instances, the value for Inventory may vary depending upon the initial Qty value set by the user. Each item listed by a seller may have a different initial Qty value.

The user may then set the notification options of Quantity Manager. For example, the user may elect to receive email notifications upon failure to revise a listing, the occurrence of low inventory (e.g. the situation in which Inventory is less than or equal to Display), or when a listing has ended due to the purchase of all available quantity of an item. The user can set these options, or make changes to them, at any time.

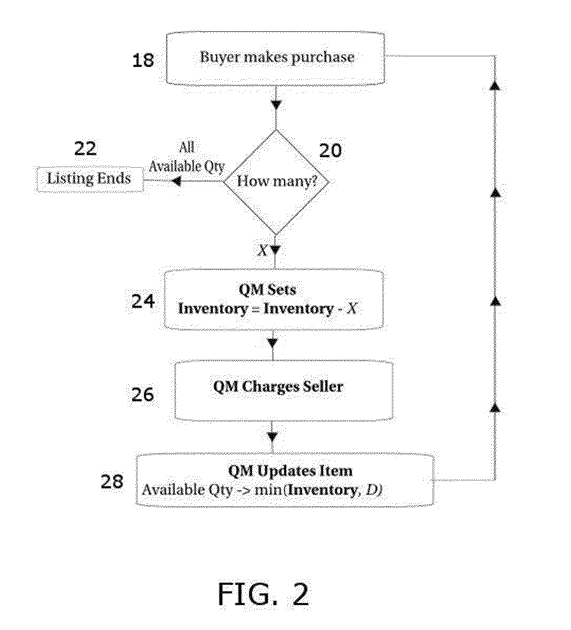

After the user's listings have been downloaded by Quantity Manager, and the user has established the desired settings, Quantity Manager functions generally as shown in FIG. 2. Quantity Manager monitors an ecommerce site in real time, and when a buyer makes a purchase of a monitored item, as represented by box 18, Quantity Manager determine how many of the items were purchased, as represented by box 20. If all available quantity was purchased, the listing ends, as represented by box 22. If quantity remains, Quantity Manager subtracts the quantity sold from the previously existing Inventory value and sets the result as the new Inventory value. This action is represented by box 24. Quantity Manager then charges the seller for this functionality (in implementations of the present invention set up as a subscription service; it is contemplated that any sales or pricing model may be used with the present method), as shown in box 26, and then updates the item listing on the ecommerce web site, setting the available quantity as predetermined by the user of the present system (box 28). Quantity Manager then continues to monitor the ecommerce site for the next activity.

The user can use Quantity Manager to deal with listings on an individual basis. The user can set the values for Display and Inventory for individual items, or for groups of up to 25, 50, 100, or 200 items. If the user has multi-variation listings on the ecommerce site, each variation or sub-listing is preferably presented along with the title of the main listing and the SKU for the variation (if applicable). Alternatively, variation keys or value pairs for the variation, such as color or size, can be presented.

User navigation through the various listings is provided in a straightforward manner. The user can navigate directly to individual listings, or can search by keyword in the listing's title or based on listing number. Searches return all listings that correspond to the searched terms or numbers, and the user can then sort the search results by various fields, including title, listing number, Qty, Inventory, Display, Price, listing Start Time, listing End Time, and the like.

The processing time for actions taken by the user may vary, from immediate actions by Quantity Manager to reflect user actions, to user actions being performed by Quantity Manager over time as the actions come due in a work queue. In an exemplary implementation of the present method, when a user adjusts four or fewer listings, Quantity Manager performs the requested actions immediately and the user receives immediate notification of any errors that have occurred as a result of the processing of the instructions. If the user attempts to make adjustments to five or more listings at once, then the desired adjustments are added to a work queue to be processed at a later time. Items are added to the work queue with the instruction “update Quantity” and marked as dirty in the database to prevent multiple updates. The ‘dirty’ marking indicates that the values for Inventory and/or Display have been changed, but that Qty has not yet been update to reflect the change.

The user may also be presented with options for setting a Global Inventory and Global Display. These options allow the user to set the Inventory and Display values for all active items at once. Further, the user may select an Inventory=Qty function, which sets the Inventory value for each item to its current Qty value. A Display=Inventory function is provided so that the user can set the Display value of all items to their Inventory value. This final functionality will essentially undo what Quantity Manager has done previously, and thus is provided as a way for the user to ‘reset’ some or all listings to their default state as determined by the ecommerce site.

The user is also provided with an overview of the user's usage of Quantity Manager, which displays to the user information such as the total number of items being monitored by Quantity Manager, the number of items active on the ecommerce site, the number of quantity refreshes over a given time period such as a month, the total number of lifetime quantity refreshes, and the like. Details of the last quantity refreshed may also be provided.

Back End

The back end of Quantity Manager involves processes and functionality that does not require direct interaction on the part of the user of the system. For example, in one implementation of the present method, the Quantity Manager includes a platform notifications listener (Listener). This aspect of Quantity Manager receives messages from the ecommerce site, such as eBay, concerning events occurring on the ecommerce site and relating to the user of Quantity Manager. This functionality is achieved via a combination of the email message or other message generated by the ecommerce site, a procmail filter, and a php script to process the message from the ecommerce site. It is contemplated, however, that this functionality may be provided in any suitable manner. The platform notification listener allows Quantity Manager to function in real time with respect to the ecommerce site.

In one aspect of the present method, the Listener determines the type of message received from the ecommerce site, then calls the appropriate function to handle the given message type. In implementations of the present method wherein the ecommerce site is eBay, for example, if the message type received from eBay is “ItemListed,” then Quantity Manager determines whether or not the listing is a fixed price listing. If the listing is not a fixed price listing, the Listener ignores the message. If, on the other hand, the listing is a fixed price listing, the message is processed by Quantity Manager and the listing is added to the Quantity Manager's database of listings for that user. Quantity Manager also determines whether the item is a relist by checking the item against all recently-ended items having the same title. If eBay reveals one of the recently-ended listings as the original listing, Quantity Manager imports the values for Inventory and Display from the original listing and applies them to the relist. If the item is not a relist, then Inventory and Display are set according to the behavior and default values chosen by the user. If the user has enabled the override function, then Qty is adjusted accordingly.

If the message type received by the Listener is “ItemRevised,” then Quantity Manager determines whether or not the listing is fixed price. If the listing is not fixed price, then Quantity Manager ignores the message. If the listing is fixed price, Quantity Manager updates the listing's information, such as the price, Qty, title, end time, and the like, in Quantity Manager's database for that user. If the item is a multi-variation listing, then each variation or sub-listing is adjusted accordingly. Variations listed on eBay can be added or removed by the user, so Quantity Manager also determines whether any such activity has taken place and, if necessary, identifies variations that have ended or adds new variations to Quantity Manager's database of listings for that user. If new variations are added, Quantity Manager adjusts Inventory, Display, and Qty as if receiving the ItemListed call.

If the message received is of the “FixedPriceTransaction” type, Quantity Manager determines whether the transaction has already been processed. If the transaction has already been processed, Quantity Manager ignores the message. If the transaction has not been processed, Quantity Manager adds the transaction to Quantity Manager's database for that user. The quantity sold is extracted from the message and subtracted from “Inventory” for the appropriate item. If Qty is zero, then the listing is marked as ended in the database and the function exits. Quantity Manager then updates Qty and Inventory as necessary. If the user has selected the option for notification when all available quantity has been purchased, and inventory is greater than zero, an email notification is sent to the user indicating that the item has ended. If Inventory is less than or equal to Display, but Inventory plus the quantity sold is greater than Display, then an email is sent to the user if the user has enabled low inventory notification in the Quantity Manager settings. If the revision of the value for Qty fails for any reason, an error message is generated and stored in the message queue.

If the message received from eBay is of any of the “ItemSuspended,” “Item Sold,” “ItemUnsold,” “or “EndOfAuction” types, Quantity Manager marks the item as ended in Quantity Manager's database of listings for that user.

If the message received from eBay is of the “TokenRevocation” type, the authorization token is removed from Quantity Manager's database of listings for that user and the user is unsubscribed.

In addition to the above, the Back End of Quantity Manager includes a work queue that includes a set of instructions to be performed at a given time or in a given sequence as determined by the position of the instruction within the queue. Such instructions may include, but are not limited to, getSellerItems, which downloads all items from the ecommerce site for a particular user and adds them to Quantity Manager's database of listings for that user, updateQuantity, which updates the Qty value for a listing and unmarks it as a dirty listing in Quantity Manager's database of listings for that user, and updateQuantityAll, which updates the Qty values for all listings for a given user and unmarks all such listings as dirty in Quantity Manager's database of listings for that user. If, for any attempted update of Qty, the update fails for any reason, an error message is generated and sent to the message queue.

Quantity Manager preferably checks the work queue for new items every five minutes via a cronjob, in a linux or unix based system, or any suitable task scheduler. It is contemplated, however, that any desired time interval for checking the work queue may be used. If Quantity Manager finds new items in the work queue, several instructions are pulled from the work queue at once and processed simultaneously. In a PHP setting, this is accomplished by forking the Quantity Manager functionality into several processes where each process handles one new instruction. If using a language that supports multiple threads, such as C or Java, this is accomplished by multiple threads launched from a single process. When a given instruction is completed it is marked as completed and removed from the queue.

The Back End of Quantity Manager also preferably includes a message queue to prevent spamming of hundreds or thousands of failure notifications to a user in a given circumstance. The message queue is preferably checked for new messages every five minutes via a cronjob, in a linux or unix environment, or any suitable task scheduler, though any suitable interval of time may be used. When new messages are found in the message queue, all messages intended for the same user are tied together into a single email message and sent to the user. This process is repeated for each user having one or more messages in the queue.

The description above provides an exemplary implementation of the present method. It is contemplated that one of skill in the art will envision certain modifications and variations on the above upon reading this disclosure, and such modifications and variations are considered to be within the scope of the present invention. Specific instruction names or field names provided above may be varied according to the need or desire of a user of the present method without departing from the spirit or scope of the present invention.

Having thus described the preferred embodiment of the invention, what is claimed as new and desired to be protected by Letters Patent includes the following:

1. A computer-implemented method for managing the quantity of at least one item on an ecommerce site, the method comprising the steps of:
a) monitoring an ecommerce site whereon at least one item of interest is listed;
b) receiving from said ecommerce site a message relating to a quantity of said at least one item of interest;
c) setting a displayed quantity of said at least one item of interest on said ecommerce site, said displayed quantity being visible to potential buyers using said ecommerce site, said displayed quantity corresponding to a predetermined value set by a user of the present method; and
d) iteratively performing steps a) through c), above, so long as said at least one item of interest is listed on said ecommerce site,
wherein said computer-implemented method is performed by at least one computer programmed to perform steps a) through d), above.

2. The method according to claim 1, wherein the step of monitoring said ecommerce site is performed in real time.

3. The method according to claim 1, further comprising the step of: e) repeating steps a) through d), above, for each of a plurality of items listed on said ecommerce site by said user of the present method.

4. A computer-implemented method for managing the quantity of at least one item listed by a user on an ecommerce site, the method comprising the steps of:
a) monitoring an ecommerce site;
b) receiving from said ecommerce site a message relating to at least one listing of at least one item of interest;
c) overriding a displayed quantity of said at least one item of interest for each of said at least one listings such that the displayed quantity corresponds to a preselected value set by a user of said computer-implemented method; and
d) iteratively performing steps a) through c), above, for each of said at least one listings on said ecommerce site for so long as said user has at least one listing on said ecommerce site,
wherein said computer-implemented method is performed by at least one computer programmed to perform steps a) through d), above.

5. The method according to claim 4, above, wherein the message received in step b) comprises information relating to a quantity of said at least one item of interest, and further wherein an electronic message is generated and transmitted to a user of the present method when said quantity reaches a value preselected by said user.

6. The method according to claim 4, wherein the step of monitoring said ecommerce site is performed in real time.

7. The method according to claim 5, wherein the step of monitoring said ecommerce site is performed in real time.

8. A computer-implemented method for managing the quantity of at least one item listed by a user on an ecommerce site, the method comprising the steps of:
a) receiving from a user of the present method information regarding at least one ecommerce site whereon said user has at least one item listed for sale;
b) prompting said user to set default values for Qty, Inventory, and
Display variables relating to said at least one item;
c) updating each of said at least one items listed on said ecommerce site to reflect said Display value set by said user;
d) monitoring said ecommerce site;
e) receiving from said ecommerce site information relating to a purchase by a buyer of said at least one item listed thereon by said user;
f) determining the quantity of said at least one item purchased by said buyer;
g) updating the value for Inventory relating to said at least one item by subtracting the quantity of said item purchased from said Inventory value;
h) updating a displayed quantity of said at least one item listed on said ecommerce site by setting said displayed quantity to a value corresponding to the lesser of said Inventory and Display values;
i) iteratively performing steps d) through h), above, for each of said at least one items listed on said ecommerce site so long as at least one item remains listed on said ecommerce site.
wherein said computer-implemented method is performed by at least one computer programmed to perform steps a) through i), above.

9. The method according to claim 8, above, wherein the step of monitoring said ecommerce site occurs in real time.

10. The method according to claim 8, above, wherein when the quantity of said at least one item sold, as determined in step f), is equal to the value of Qty, an electronic message is generated and transmitted to said user indicating that the listing for said at least one item has ended.

11. The method according to claim 8, above, wherein when the updated Inventory value determined in step g) is less than or equal to a preselected value set by said user, an electronic message is generated and transmitted to said user indicating that the Inventory value relating to said at least one item is low.
